(19) United States
(12) Patent Application Publication
(10) Pub. No.: US 2007/0280625 A1
(43) Pub. Date: Dec. 6, 2007

(54) Optical member support mechanism, optical device, and gap adjusting member

(75) Inventor: Koji Kawaguchi, Saitama (JP)

Correspondence Address: FOLEY AND LARDNER LLP;SUITE 500, 3000 K STREET NW, WASHINGTON, DC, 20007, US

(73) Assignee: TAMRON CO., LTD.

(21) Appl. No.: 11/518,203

(22) Filed: Sep. 11, 2006

(30) Foreign Application Priority Data
May 31, 2006 (JP) 2006-152374

(51) Int. Cl. G02B 6/00

(52) U.S. Cl. 385/147

(57) ABSTRACT

An l1 lens and an L2 lens are aligned along an optical axis of a zoom lens device, and are held on a fixed lens holding frame. The fixed lens holding frame is mounted on a second mirror cylinder that has a mounting surface facing the fixed lens holding frame in a direction of the optical axis. A leaning gap adjusting plate is interposed between the fixed lens holding frame and the second mirror cylinder. The leaning gap adjusting plate causes force to act on the fixed lens holding frame and the second mirror cylinder in such a direction that the fixed lens holding frame and the second mirror cylinder are separated away from each other.

### BACKGROUND OF THE INVENTION

1. Field of the Invention

The present invention relates to an optical member support mechanism, an optical device, and a gap adjusting member.

2. Description of the Related Art

Conventionally, such an optical device has been in use that has a plurality of optical members aligned along one optical axis. When the optical device is, for example, manufactured by simply assembling components (hereinafter, “simple assembling”), the optical precision of the optical device directly reflects the manufacturing precision of each component composing the optical device. Each component, therefore, must be properly managed so as to keep the manufacturing precision of each component high.

As such an optical device manufactured by the simple assembling seeks for higher optical performance or smaller device size, required manufacturing precision of each component becomes higher. This leads to a decline in the manufacturing yield of each component, resulting in the low manufacturing yield or the high manufacturing cost of the optical device.

Various techniques have been devised to adjust the inclination of the optical axis of any desired optical member so as to align the optical axis of each optical member on the same optical axis in an optical device. One technique, for example, enables adjustment of the inclination of the optical axis of any desired lens by providing a gap adjusting member, such as a washer, between a lens holding frame, which holds the lens, and a mounting member, on which the lens holding member is mounted.

Another technique features a single compressive coil spring that is set in contact with a lens holding frame along its outer periphery between the lens holding frame, which holds a lens, and a mounting member, on which the lens holding frame is mounted. Across the coil spring, the lens holding frame is anchored to the mounting member via screws at two spots that are opposite to each other with regard to the center of the lens (for example, Japanese Patent Laid-Open Publication No. 2000-352648).

Another technique offers such a structure that a plurality of coil springs are provided on the back side of the surface of a mirror, which is to be mounted on a mounting member, and a plurality of spots on the periphery of the mirror are fixed with screws (for example, Japanese Utility Model Laid-Open Publication No. S50-56145). According to the techniques disclosed in Japanese Patent Laid-Open Publication No. 2000-352648 and Japanese Utility Model Laid-Open Publication No. 1975-56145, the inclination of the lens axis, which is to be adjusted, is adjusted by adjusting the extent of tightening the screws.

In the technique featuring the gap adjusting member, the number of components increases because the gap adjusting member increases in number as spots to be adjusted multiplies. In addition, the technique requires complicated adjustment work because the already mounted lens holding frame has to be removed when the gap adjusting member is to be mounted on the optical device.

In the technique employing a single compressive coil spring disclosed in Japanese Patent Laid-Open Publication No. 2000-352648, the state of compression of the compressive coil spring becomes partially biased in accordance with the extent of tightening of each screw, resulting in nonuniform force applied to the lens holding member by the compressive coil spring. Thus, the lens holding frame cannot be stably mounted.

In the technique described in Japanese Utility Model Laid-Open Publication No. S50-56145, for example, if the spots to be fixed with screws (hereinafter “adjusting spot”) are increased to improve precision in adjustment, the number of the coil springs is also increased. As a result, the higher the adjustment precision becomes, the more the components increases, and adjustment work becomes more complicated.

### SUMMARY OF THE INVENTION

It is an object of the present invention to at least solve the above problems in the conventional technologies.

An optical member support mechanism according to one aspect of the present invention includes a holding member configured to hold an optical member among a plurality of optical members aligned along an optical axis; a supporting member having a mounting surface facing the holding member in a direction of the optical axis; a mounting unit configured to mount the holding member on the supporting member; and a gap adjusting member arranged between the holding member and the supporting member. The gap adjusting member is configured to apply force acting on the holding member and the supporting member in such a direction that the holding member and supporting member are separated away from each other.

An optical member support mechanism according to another aspect of the present invention includes a holding member configured to hold an optical member among a plurality of optical members aligned along an optical axis; a supporting member having a mounting surface facing the holding member in a direction of the optical axis; and a mounting unit configured to mount the holding member on the supporting member. At least one of the holding member and the supporting member is configured to apply force acting on at least one of the holding member and the supporting member in such a direction that the holding member and supporting member are separated away from each other.

An optical device according to still another aspect of the present invention includes the optical members supported by the optical member support mechanism according to the above aspect.

A gap adjusting member according to still another aspect of the present invention is arranged between a holding member and a supporting member. The holding member is configured to hold an optical member among a plurality of optical members aligned along an optical axis, and the supporting member has a mounting surface facing the holding member in a direction of the optical axis. The gap adjusting member includes bent portions that have elasticity and are formed by bending a part of the gap adjusting member toward at least one of the holding member and the mounting surface. The gap adjusting member is configured to apply force acting on the holding member and the supporting member in such a direction that the holding member and supporting member are separated away from each other.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-section of a zoom lens device according to a first embodiment of the present invention;

FIG. 2 is a perspective view of a leaning gap adjusting plate;

FIG. 3 is an exploded view of a part of the zoom lens device;

FIG. 4 is a front view of the zoom lens device;

FIG. 5 is a cross-section of the zoom lens device taken along a line A-A shown in FIG. 4;

FIG. 6 is a cross-section of a part of the zoom lens device;

FIG. 7 is a front view of the zoom lens device;

FIG. 8 is a cross-section of the zoom lens device taken along a line A-A shown in FIG. 7;

FIG. 9 is another front view of the zoom lens device;

FIG. 10 is a cross-section of the zoom lens device taken along a line A-A shown in FIG. 9;

FIG. 11 is a perspective view of a modification of the leaning gap adjusting plate;

FIG. 12 is a perspective view of another modification of the leaning gap adjusting plate;

FIG. 13 is an exploded view of a part of a zoom lens device according to a second embodiment of the present invention; and

FIG. 14 is a cross-section of a part of a zoom lens device according to a third embodiment of the present invention.

### DETAILED DESCRIPTION OF THE PREFERRED EMBODIMENTS

Exemplary embodiments according to the present invention will be explained in detail below with reference to the accompanying drawings. In the embodiments, application of an optical member support mechanism, an optical device, and a gap adjusting member according to the present invention to a zoom lens device is explained as an example.

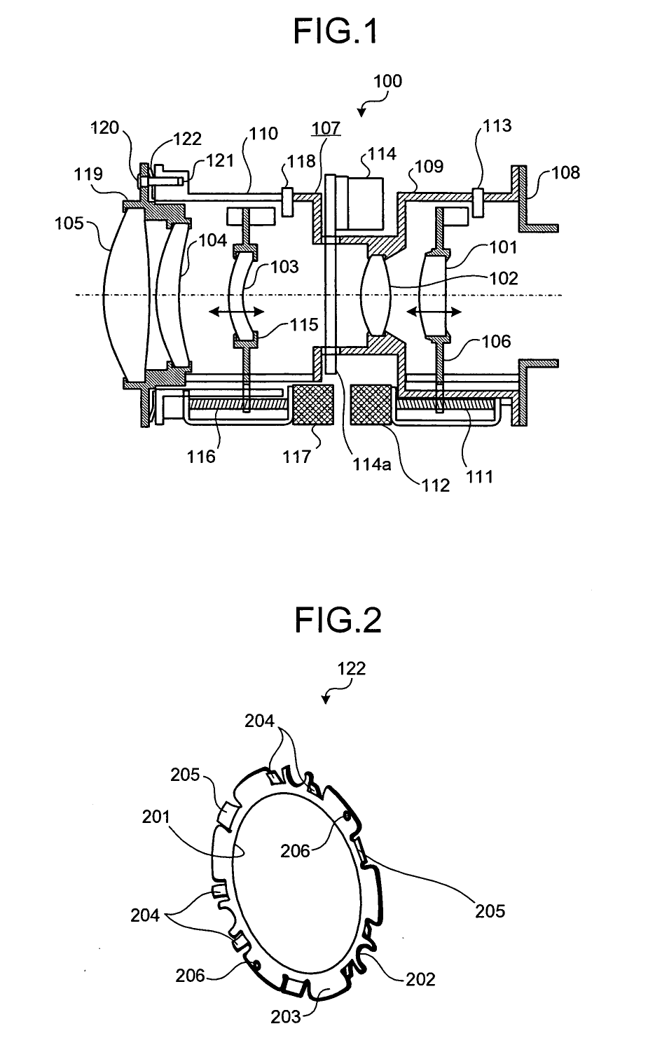

FIG. 1 is a cross-section of a zoom lens device according to a first embodiment of the present invention. As shown in FIG. 1, a zoom lens device 100 includes a plurality of lenses 101 to 105 aligned along a single optical axis. Among the lenses 101 to 105, the lens 101 (hereinafter, “L5 lens”) is held with an L5 lens moving frame 106, and is set inside a mirror cylinder 107.

The mirror cylinder 107 has a substantially cylindrical shape having the axis in the same direction as the optical axis of the zoom lens device 100, and includes a first mirror cylinder 109 mounted on a mount 108 and a second mirror cylinder 110 fit to the first mirror cylinder 109. The second mirror cylinder 110 is located at the opposite side to the mount 108 via the first mirror cylinder 109. The second mirror cylinder 110.

The L5 lens moving frame 106 is capable of moving only the direction of the optical axis. A part of the L5 lens moving frame 106 is located at the outside of the first mirror cylinder 109, where the part is connected to a shaft 111 arranged at the outside of the first mirror cylinder 109. The shaft 111 has a bar-like shape extending in the direction of the optical axis, and has a screw thread formed on an outer peripheral surface of the shaft 111. The L5 lens moving frame 106 engages its screw thread with the screw thread formed on the shaft 111, thereby connecting to the shaft 111.

A motor 112 is attached to one end of the shaft 111, where the motor 112 rotates the shat 111 about the axial center of the shaft 111. As the shaft 111 is rotated by the rotation of the motor 112, the L5 lens moving frame 106 connected to the shaft 111 moves along the screw thread of the shaft 111 in a direction corresponding to the direction of the rotation of the motor 112. In this manner, the L5 lens 101 is moved in the direction of the optical axis. The position of the L5 lens 101 in the direction of the optical axis is detected based on an output value from an optical sensor 113.

Among the lenses 101 to 105, the lens 102 (hereinafter “L4 lens”) is held with the first mirror cylinder 109. The first mirror cylinder 109 is provided with a diaphragm unit 114, which has a diaphragm wing 114a and is located at the opposite side to the L5 lens 101 via the L4 lens 102.

The diaphragm wing 114a is structured to be able to change the size of an aperture. Since such a diaphragm wing is a known technique, further explanation of the structure of the diaphragm wing 114a is omitted. A brightness diaphragm wing, etc., for example, is employed as the diaphragm wing 114a. The diaphragm unit 114 drives and controls the diaphragm wing 114a to change the size of the aperture provided by the diaphragm wing 114a when brightness for the L4 lens 102 is adjusted.

Among the lenses 101 to 105, the lens 103 (hereinafter “L3” lens) is set inside the second mirror cylinder 110, and is held with an L3 lens moving frame 115. The L3 lens moving frame 115 is capable of moving only the direction of the optical axis. A part of the L3 lens moving frame 115 is located at the outside of the second mirror cylinder 110, where the part is connected to a shaft 116 arranged at the outside of the second mirror cylinder 110.

Similarly to the shaft 111, the shaft 116 has a bar-like shape extending in the direction of the optical axis, and has a screw thread formed on an outer peripheral surface of the shaft 116. The L3 lens moving frame 115 engages its screw thread with the screw thread formed on the shaft 116, thereby connecting to the shaft 116.

A motor 117 is attached to one end of the shaft 116, where the motor 117 rotates the shaft 116 about the axial center of the shaft 116. In a similar manner as the L5 lens moving frame 106, the L3 lens moving frame 115 connected to the shaft 116 moves along the screw thread of the shaft 116 as the shaft 116 is rotated by the rotation of the motor 117, thereby moving the L3 lens 103 in the direction of the optical axis. The position of the L3 lens 103 in the direction of the optical axis is detected based on an output value from an optical sensor 118.

Among the lenses 101 to 105, the lenses 104 and 105 (hereinafter “L2 lens” and “l1 lens”, respectively) are held with a fixed lens holding frame 119 serving as a holding member. The fixed lens holding frame 119 is mounted on the second mirror cylinder 110 so as to be located at the opposite side to the first mirror cylinder 109.

The fixed lens holding frame 119 is mounted on the second mirror cylinder 110 using adjusting screws 120 having pin-like members. The adjusting screws 120 are screwed into screw holes 121 formed on the second mirror cylinder 110 at three spots that are dotted about at substantially equal intervals on a concentric circle having its center on the optical axis of the zoom lens device 100. According to the first embodiment, the adjusting screws 120 and the screw holes 121 constitute a mounting unit. A leaning gap adjusting plate 122 is disposed between the fixed lens holding frame 119 and the second mirror cylinder 110.

The leaning gap adjusting plate 122 is formed of metal, engineering plastic, etc. The engineering plastic, specifically, includes polycarbonate and polyphenylene sulfide (PPS). The leaning gap adjusting plate 122 has an elasticity that allows the leaning adjusting plate 122 to return to its original shape when external force having strength within a given range is applied to deform the leaning adjusting plate 122.

In the example in the first embodiment, optical members are the lenses 101 to 105, and the l1 lens 105 and the L2 lens 104 are provided as any desired optical members. The optical members aligned along the optical axis may be the L5 lens moving frame 106, the mirror cylinder 107, the diaphragm wing 114a, and the L3 lens moving frame 115.

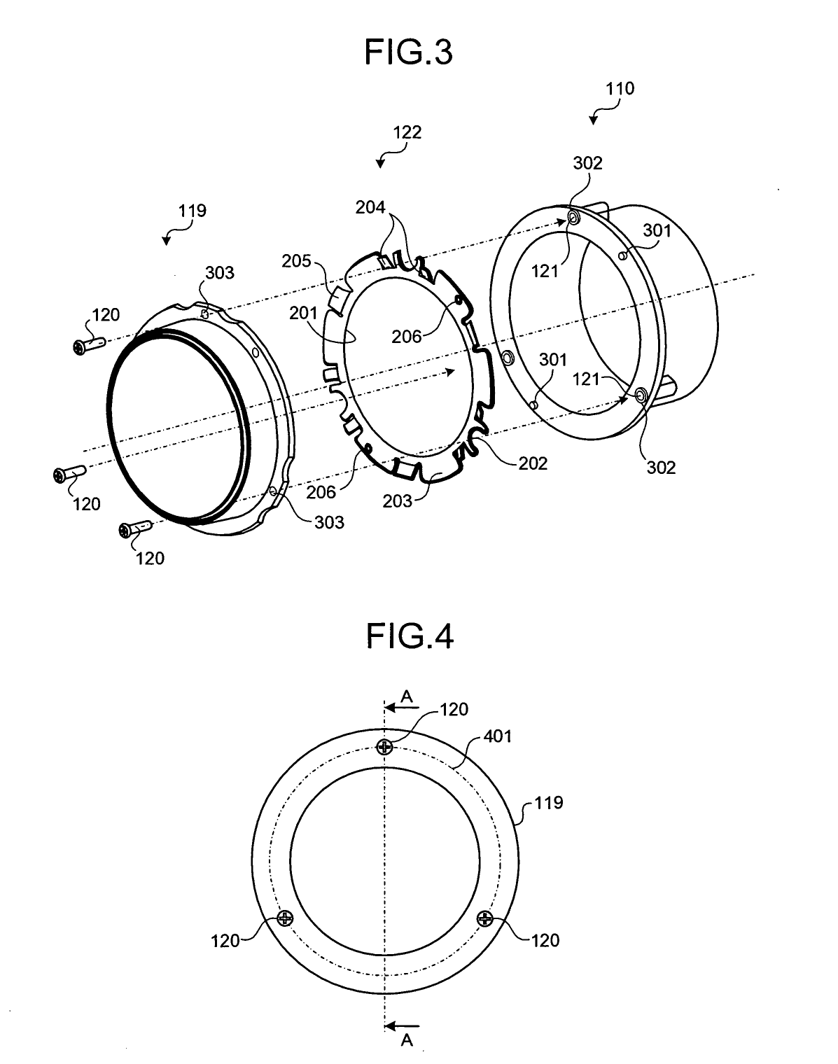

FIG. 2 is a perspective view of the leaning gap adjusting plate 122. As shown in FIG. 2, the leaning gap adjusting plate 122 is a tabular member having an opening 201 in a central portion. In the opening 201, the fixed lens holding frame 119 is inserted. The opening 201 is of a circular shape having its center coaxial to the optical axis of the zoom lens device 100. The leaning gap adjusting plate 122 is provided with recessions 202 that are so formed as to avoid the edges of the screw holes 121 (see FIG. 3) formed on the second mirror cylinder 110.

The leaning gap adjusting plate 122 has a base portion 203 formed at the outer edge of the opening 201, and bent portions 204 and 205. The base portion 203 extends in a direction away from the center of the opening 201 on a plane perpendicular to the optical axis of the zoom lens device 100. The bent portions 204, 205 are bent from the plane perpendicular to the optical axis of the zoom lens device 100 toward the fixed lens holding frame 119.

The bent portions 204, 205 have such bent shape that the bent portions 204, 205 are positioned closer to the fixed lens holding frame 119 as they goes away further from the center of the opening 201. Each bent portion 204 is formed near each recession 202. Specifically, each bent portion 204 is located at both sides of each recession 202 on the same circumference of a circle having its center coinciding with the center of the opening 201. Every bent portion 204 is formed so as to have the same size and the same bent angle toward the fixed lens holding frame 119.

Each bent portion 205 is formed in substantially in the middle between adjacent recessions 202 such that the bent portion 205 is formed at three spots that are dotted at substantially equal intervals along a circle concentric with the opening 201. Every bent portion 205 is formed so as to have the same size and the same bent angle toward the fixed lens holding frame 119.

The bent portion 205 is formed to be larger than the bent portion 204 according to the first embodiment, but the relation in size between the bent portions 204, 205 is not limited to the relation shown in FIG. 2. The bent portions 204, 205 can be designed to have optimum sizes according to the shape of a place where the leaning gap adjusting plate 122 is mounted.

The bent angle of each bent portion 205 toward the fixed lens holding frame 119 is the same as the bent angle of each bent portion 204. The leaning gap adjusting plate 122 is provided with positioning holes 206 into which positioning pins formed on the second mirror cylinder 110 (see FIG. 3) are inserted.

FIG. 3 is an exploded view of a part of the zoom lens device 100. Reference character 301 denotes the positioning pins inserted into the above positioning holes 206, and reference character 302 denotes the above edges of the screw holes 121. Inserting the position pins 301 into the positioning holes 206 determine the position of the leaning gap adjusting plate 122 against the second mirror cylinder 110.

According to the first embodiment, the part of the second mirror cylinder 110 that faces the leaning gap adjusting plate 122 is defined as a mounting surface. On the mounting surface, screw spots where the adjusting screws 120 are screwed into the screw holes 121 are defined as mounting positions.

As shown in FIG. 3, the adjusting screws 120 are screwed into the screw holes 121 via through-holes 303 formed on the fixed lens holding frame 119 while the leaning gap adjusting plate 122 is positioned between the fixed lens holding frame 119 and the second mirror cylinder 110. Engagement between the adjusting screws 120 and the screw holes 121 fixes the position of the leaning gap adjusting plate 122.

As the adjusting screws 120 are screwed down into the screw holes 121 to cause the fixed lens holding frame 119 and the second mirror cylinder 110 to approach each other, the front end of each of the bent portions 204, 205 comes in contact with the fixed lens holding frame 119. Form this point, the adjusting screws 120 are tightened further, which causes the fixed lens holding frame 119 to push the front end of each of the bent portions 204, 205 to deform the bent portions 204, 205. In deformation, the front end moves toward the second mirror cylinder 110.

As mentioned above, the leaning gap adjusting plate 122 has an elasticity, because of which the deformed bent portions 204, 205 exert restitutive force and try to return to their original state. This restitutive force works as force acting on the fixed lens holding frame 119 in a direction of separating the fixed lens holding frame 119 relatively away from the second mirror cylinder 110. As a result, according to the zoom lens device 100, the unsteadiness of the fixed lens holding frame 119 against the second mirror cylinder 110 is suppressed to allow stable mounting of the l1 lens 105 and the L2 lens 104.

FIG. 4 is a front view of the zoom lens device 100. FIG. 4 illustrates the zoom lens device 100 viewed from a side on which of the l1 lens 105 is arranged. A virtual line denoted by a reference character 401 in FIG. 4 describes a circle having its center coinciding with the optical axis of the zoom lens device 100. As shown in FIG. 4, the adjusting screws 120 and the screw holes 121 are located along the same circle concentric with the optical axis of the zoom lens device 100.

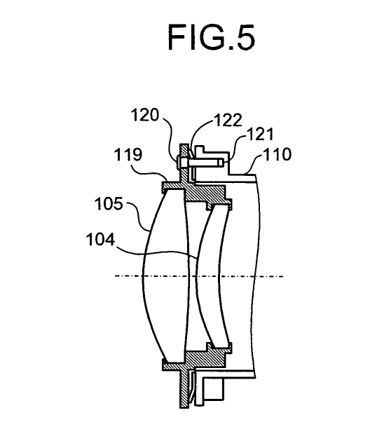

FIG. 5 is a cross-section of the zoom lens device 100 taken along a line A-A shown in FIG. 4. FIG. 5 illustrates a cross-section of the surrounding area of the l1 lens 105 in the zoom lens device 100. As shown in FIG. 5, the leaning gap adjusting plate 122 is incorporated into the zoom lens device 100 in such a way that the base portion 203 is in contact with the second mirror cylinder 110, and that the front end of each of the bent portions 204, 205 is in contact with the fixed lens holding frame 119.

A gap between the second mirror cylinder 110 and the fixed lens holding frame 119, which face each other across the leaning gap adjusting plate 122, is determined to be larger than the thickness of the leaning gap adjusting plate 122. This ensures that the above described force acts on the fixed lens holding frame 119 even if the zoom lens device 100 is manufactured by simple assembling.

Thus, according to the zoom lens device 100, the unsteadiness of the fixed lens holding frame 119 against the second mirror cylinder 110 is suppressed to allow stable mounting of the l1 lens 105 and the L2 lens 104 even if the zoom lens device 100 is manufactured by simple assembling.

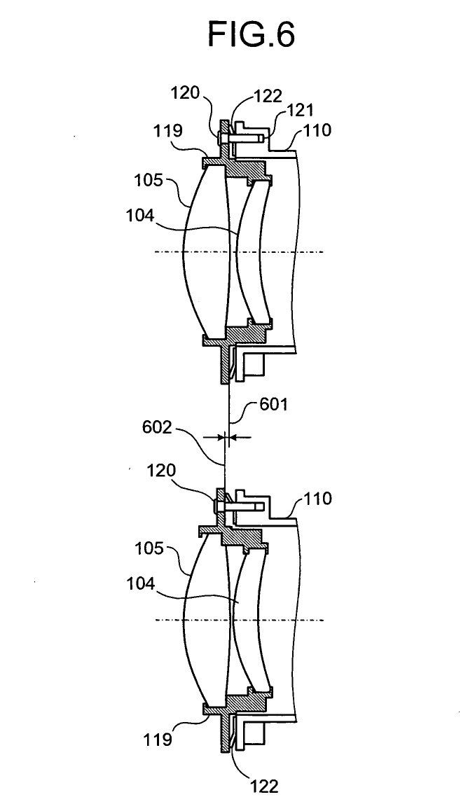

FIG. 6 is a cross-section of a part of the zoom lens device 100. FIG. 6 illustrates a cross-section of a surrounding area of the l1 lens 105 in the zoom lens device 100. As shown in FIG. 6, the position of the fixed lens holding frame 119 against the second mirror cylinder 110 can be adjusted by adjusting the extent of screwing of the adjusting screws 120 into the screw holes 121. A top side in the figure in the top-and-bottom direction on the paper surface expresses a state of the fixed lens holding frame 119 before positional adjustment, and a bottom side expresses a state of the fixed lens holding frame 119 after the positional adjustment.

When the adjusting screws 120 are turned in an unscrewing direction, an amount in which the adjusting screws 120 are screwed in the screw holes 121 decreases. Thus, the fixed lens holding frame 119 is moved in the direction away from the second mirror cylinder 110. For example, when the fixed lens holding frame 119 is located at a reference position 601 shown in FIG. 6, by turning the adjusting screws 120 in the unscrewing direction, the fixed lens holding frame 119 is moved to a shifted position 602.

As shown in FIG. 6, the leaning gap adjusting plate 122 certainly causes the above force to act on the fixed lens holding frame 119 even when the fixed lens holding frame 119 moves to the shifted position 602.

According to the zoom lens device 100, the unsteadiness of the fixed lens holding frame 119 against the second mirror cylinder 110 is suppressed to allow stable mounting of the l1 lens 105 and the L2 lens 104 even if the position of the fixed lens holding frame 119 against the second mirror cylinder 110 is adjusted.

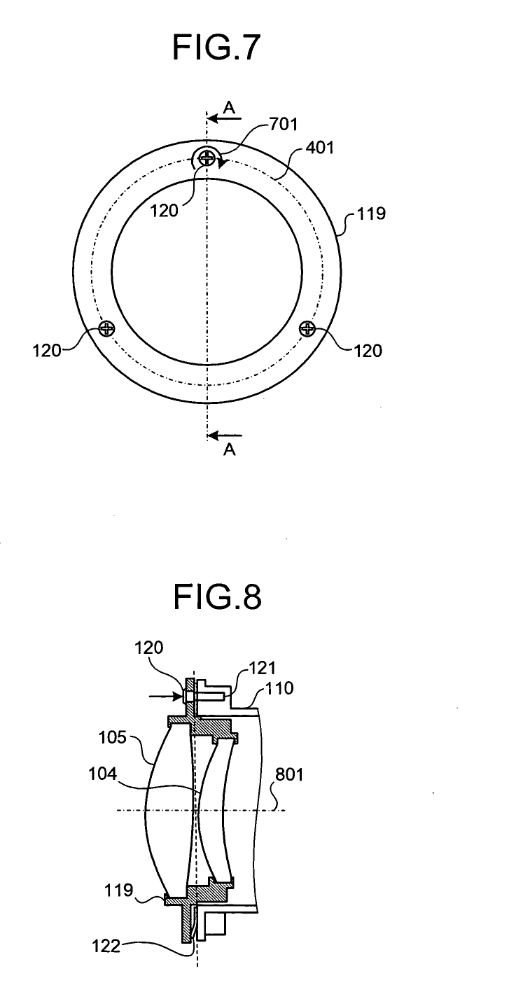

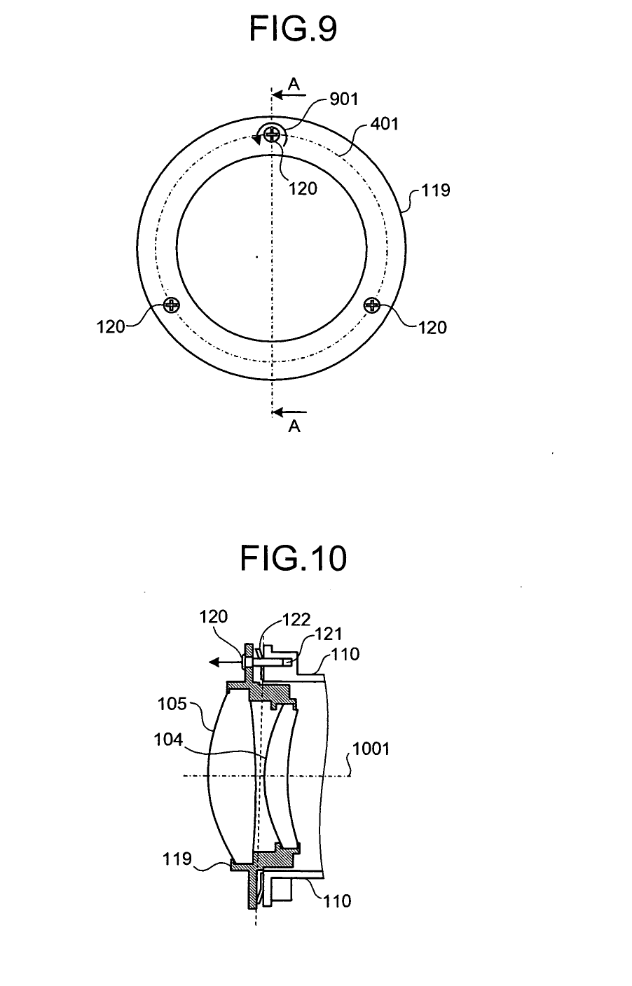

FIG. 7 is a front view of the zoom lens device 100. FIG. 8 is a cross-section of the zoom lens device 100 taken along a line A-A shown in FIG. 7. FIG. 9 is another front view of the zoom lens device 100. FIG. 10 is a cross-section of the zoom lens device 100 taken along a line A-A shown in FIG. 9. FIGS. 7 and 9 illustrate the zoom lens device 100 viewed from the side on which the l1 lens 105 is arranged. FIGS. 8 and 10 illustrate a surrounding area of the l1 lens 105 in the zoom lens device 100.

A method for adjusting the optical axis of the l1 lens 105 and the L2 lens 104 is with reference to FIGS. 7 to 10. According to the zoom lens device 100, the direction of optical axis of the l1 lens 105 and the L2 lens 104 is adjusted by adjusting an amount in which the adjusting screws 120 are screwed in the screw holes 121.

For example, when the adjusting screws 120 are turned in an arrowed direction 701 shown in FIG. 7, the amount (extent of engagement) in which the adjusting screws 120 are screwed in the screw holes 121 increases. Thus, the second mirror cylinder 110 and the fixed lens holding frame 119 approach relatively each other. On the other hand, when any one of the adjusting screws 120 arranged at three spots is turned in the tightening direction, the fixed lens holding frame 119 rotates about the axial center that is defined by the line passing through the two spots where two other non-turned adjusting screws 120 are inserted on the fixed lens holding frame 119.

Thus, the inclination of the optical axis of the l1 lens 105 and the L2 lens 104, the optical axis being denoted by a reference numerical 801 in FIG. 8, is adjusted in such a way that the l1 lens 105 side of the optical axis 801 moves to the top side in the top-to-bottom direction on the paper surface of FIG. 7, while the L2 lens 104 side of the optical axis 801 moves to the bottom side in the top-to-bottom direction on the paper surface in FIG. 7.

When the adjusting screws 120 are turned in an arrowed direction 901 shown in FIG. 9, for example, the amount in which the adjusting screws 120 are screwed in the screw holes 121 decreases. Thus, the second mirror cylinder 110 and the fixed lens holding frame 119 separate relatively away from each other. On the other hand, when any one of the adjusting screws 120 arranged at three spots is turned in the unscrewing direction, the fixed lens holding frame 119 rotates about the axial center that is defined by the line passing through the two spots where the other non-turned two adjusting screws 120 are inserted on the fixed lens holding frame 119.

Thus, the inclination of the optical axis of the l1 lens 105 and the L2 lens 104, the optical axis being denoted by a reference character 1001 in FIG. 10, is adjusted in such a way that the l1 lens 105 side of the optical axis 1001 moves to the bottom side in the top-to-bottom direction on the paper surface of FIG. 7, while the L2 lens 104 side of the optical axis 1001 moves to the top side in the top-to-bottom direction on the paper surface of FIG. 7.

The zoom lens device 100 of the first embodiment is provided with the adjusting screws 120 that are arranged at three spots at substantially equal intervals along the circle concentric with the optical axis. This enables adjustment of the inclination of the optical axis of the l1 lens 105 and the L2 lens 104 over the entire perimeter of the optical axis. The number of the adjusting screws 120 arranged is determined to be three. This number is the minimum number of the adjusting screws 120 that is required to be able to adjust the inclination of the optical axis of the l1 lens 105 and the L2 lens 104 over the entire perimeter of the optical axis.

As described above, according to the zoom lens device 100 of the first embodiment, the adjusting screws 120 are screwed into the screw holes 121 while the leaning gap adjusting plate 122 is positioned between the fixed lens holding frame 119 and the mounting surface of the second mirror cylinder 110. This enables suppression of the unsteadiness of the fixed lens holding frame 119 against the second mirror cylinder 110, thus allows stable mounting of the l1 lens 10S and the L2 lens 104.

According to the zoom lens device 100 of the first embodiment, the unsteadiness of the fixed lens holding frame 119 against the second mirror cylinder 110 can be suppressed only by screwing the adjusting screws 120 into the screw holes 121 while the leaning gap adjusting plate 122 is positioned between the fixed lens holding frame 119 and the mounting surface of the second mirror cylinder 110. This allows stable mounting of the l1 lens 105 and the L2 lens 104.

According to the zoom lens device 100 of the first embodiment, the unsteadiness of the fixed lens holding frame 119 against the second mirror cylinder 110 is suppressed while the leaning gap adjusting plate 122 is kept interposed between the fixed lens holding frame 119 and the second mirror cylinder 110. The state of mounting of the l1 lens 105 and the L2 lens 104, therefore, can be adjusted easily as the fixed lens holding frame 119 is kept mounted on the second mirror cylinder 110.

According to the zoom lens device 100 of the first embodiment, the bent portions 204 and 205 formed integrally on the leaning gap adjusting plate 122 suppress the unsteadiness of the fixed lens holding frame 119 against the second mirror cylinder 110. This allows stable mounting of the l1 lens 105 and the L2 lens 104 with fewer components and assembling processes.

According to the zoom lens device 100 of the first embodiment, the bent portions 204, 205 can be manufactured together with the leaning gap adjusting plate 122, using such a method as press working, injection molding, etc. The leaning gap adjusting plate 122, therefore, can be manufactured easily.

According to the zoom lens device 100 of the first embodiment, the distance between the fixed lens holding frame 119 and the mounting surface of the second mirror cylinder 110 can be changed by adjusting the amount in which the adjusting screws 120 are screwed in the screw holes 121. The state of mounting of the l1 lens 105 and the L2 lens 104, therefore, can be adjusted easily without removing the fixed lens holding frame 119 from the second mirror cylinder 110 after the zoom lens device 100 has been assembled.

According to the zoom lens device 100 of the first embodiment, the direction of the optical axis of the l1 lens 105 and the L2 lens 104 held on the fixed lens holding frame 119 can be adjusted by adjusting the amount in which the adjusting screws 120 are screwed in the screw holes 121 at each mounting position, and the force is caused to act on each screwing spot after the adjustment. This allows stable mounting of the l1 lens 105 and the L2 lens 104, and easy and highly precise adjustment of the state of mounting of the l1 lens 105 and the L2 lens 104.

According to the zoom lens device 100 of the first embodiment, after adjustment of the direction of the optical axis of the l1 lens 105 and the L2 lens 104, each bent portion 205 formed in the middle between adjacent screwing spots causes the force to act uniformly on each of the adjacent screwing spots. This allows stable mounting of the l1 lens 105 and the L2 lens 104, and easy and highly precise adjustment of the state of mounting of the l1 lens 105 and the L2 lens 104.

According to the zoom lens device 100 of the first embodiment, the screwing spots are provided at three points on the perimeter of the optical axis to limit the number of the screwing spots to the minimum. This allows stable mounting of the l1 lens 105 and the L2 lens 104, and easy and highly precise adjustment of the state of mounting of the l1 lens 105 and the L2 lens 104.

The shape of the leaning gap adjusting plate 122 is not limited to the one that is described in the first embodiment. Another leaning gap adjusting plate, for example, with the bent portions 204, 205 at different positions, of different shapes, and/or in the different number, or with the opening 201 of a different shape may be applied to the zoom lens device 100, instead of the leaning gap adjusting plate 122.

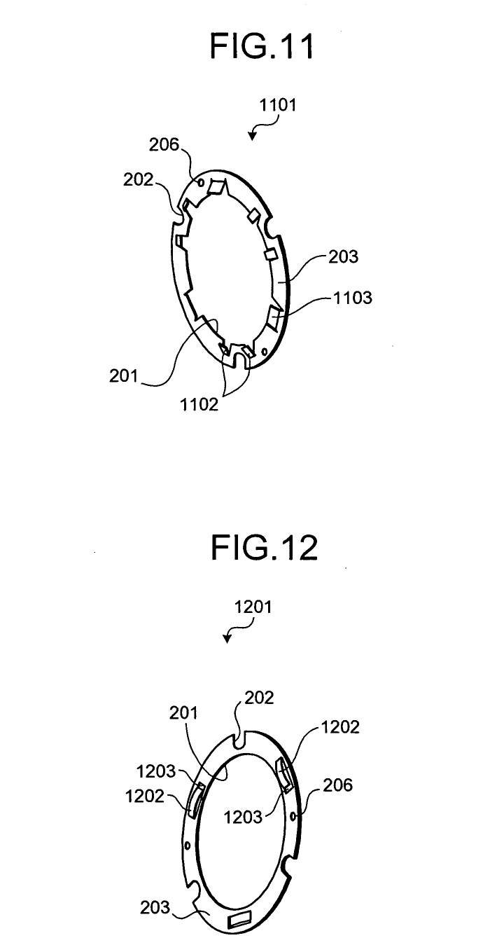

FIG. 11 is a perspective view of a modification of the leaning gap adjusting plate. The leaning gap adjusting plate 1101 shown in FIG. 11 is placed between the fixed lens holding frame 119 and the second mirror cylinder 110 instead of the leaning gap adjusting plate 122 incorporated into the zoom lens device 100 of the first embodiment.

As shown in FIG. 11, the leaning gap adjusting plate 1101 includes the opening 201, the recessions 202, the base portion 203, and the positioning holes 206. The leaning gap adjusting plate 1101 also has bent portions 1102, 1103 having bent so as to be positioned closer to the fixed lens holding frame 119 as they approach the center of the opening 201.

Each bent portion 1102 is located at both sides of each recession 202 along a circle concentric with the opening 201. Every bent portion 1102 is so formed as to have the same size and the same bent angle toward the fixed lens holding frame 119.

The bent portions 1103 are formed at three spots that are dotted at substantially equal intervals along the circle concentric with the opening 201, where each bent portion 1103 is located in substantially the middle between each of adjacent recessions 202. Every bent portion 1103 is so formed as to have the same size and the same bent angle toward the fixed lens holding frame 119.

The zoom lens device 100 provided with the leaning gap adjusting plate 1101 also allows stable mounting of the l1 lens 105 and the L2 lens 104, and easy and highly precise adjustment of the state of mounting of the l1 lens 105 and the L2 lens 104.

FIG. 12 is a perspective view of another modification of the leaning gap adjusting plate. A leaning gap adjusting plate 1201 shown in FIG. 12 is placed between the fixed lens holding frame 119 and the second mirror cylinder 110 in replacement of the leaning gap adjusting plate 122 incorporated into the zoom lens device 100 of the first embodiment.

As shown in FIG. 12, the leaning gap adjusting plate 1201 includes the opening 201, the recessions 202, the base portion 203, and the positioning holes 206. The leaning gap adjusting plate 1201 also has bent portions 1202, each of which is a member that is tangentially elongated relative to the leaning gap adjusting plate 1201 and that has the longitudinal center curved to be positioned toward the fixed lens holding frame 119. Every bent portion 1202 is so formed as to have the same size and the same extent of bent.

Each bent portion 1202 is located at both sides of each recession 202 on the same circumference of the circle having its center coinciding with the center of the opening 201. One longitudinal end of each bent portion 1202 is fixed to the base portion 203. On the leaning gap adjusting plate 1201, a space 1203 is formed between the other longitudinal end of each bent portion 1202 and the base portion 203 longitudinally.

When the leaning gap adjusting plate 1201 is incorporated into the zoom lens device 100, the longitudinal centers of the bent portions 1202, the longitudinal centers being curved to be positioned toward the fixed lens holding frame 119, are kept in contact with the fixed lens holding frame 119.

Since the spaces 1230 are formed between the other ends of the bent portions 1202 and the base portion 203 longitudinally, the bent portions 1202 deform elastically to move the other ends into the spaces 1203 to eliminate the curves of the bent portions as the adjusting screws 120 are turned in the tightening direction when the bent portions 1202 are in contact with fixed lens holding frame 119.

The zoom lens device 100 provided with the leaning gap adjusting plate 1201 instead of the leaning gap adjusting plate 122 also allows stable mounting of the l1 lens 105 and the L2 lens 104, and easy and highly precise adjustment of the state of mounting of the l1 lens 105 and the L2 lens 104.

The bent portions formed on the leaning gap adjusting plates 122, 1101, and 1201 are not limited to bent portions bent in the same direction. The bent portions 204, 205 of the leaning gap adjusting plates 122, for example, may be bent in reverse in the direction of the optical axis. Likewise, for example, the bent portions 1102, 1103 of the leaning gap adjusting plates 1101 may be bent in reverse in the direction of the optical axis.

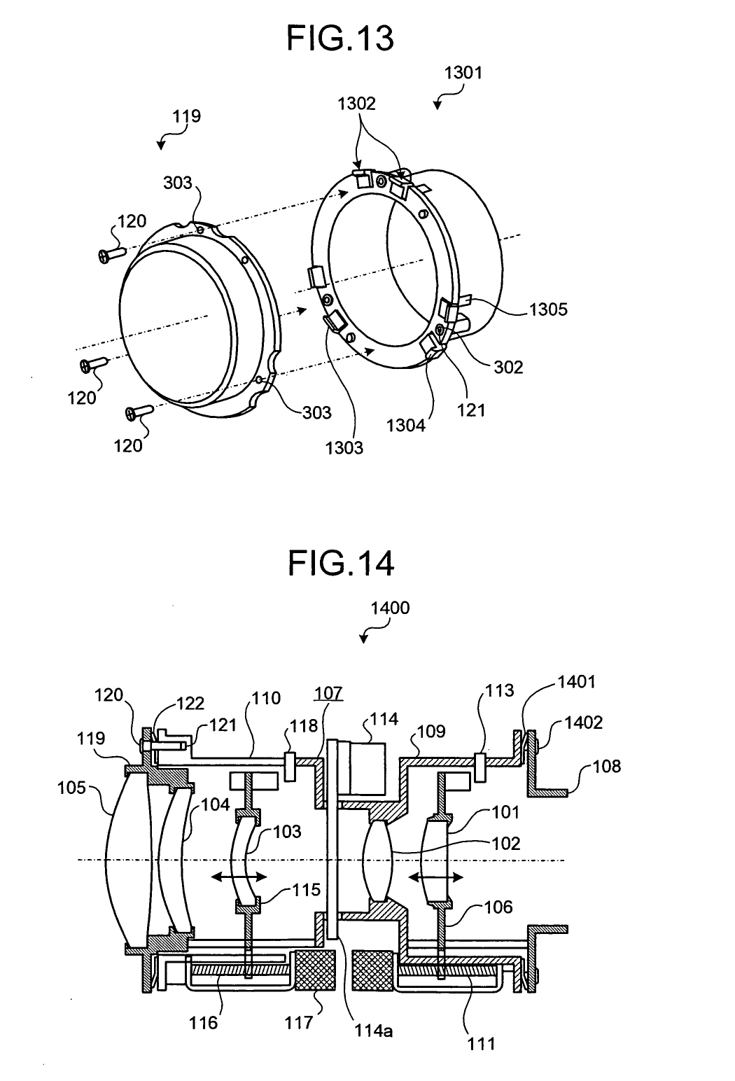

FIG. 13 is an exploded view of a part of a zoom lens device according to a second embodiment of the present invention. In FIG. 13, the same components as in the first embodiment are denoted by the same reference characters given in the first embodiment, and are not described further. As shown in FIG. 13, the zoom lens device according to the second embodiment includes a second mirror cylinder 1301 instead of the second mirror cylinder 110 in combination with the fixed lens holding frame 119 incorporated into the zoom lens device 100 of the first embodiment.

The second mirror cylinder 1301 has bent portions 1302 in addition to the screw holes (including edges 302) and the positioning pins 301. Each bent portion 1302 is located at both sides of each edge 302 along a circle concentric with the second mirror cylinder 1301.

Each bent portion 1302 includes a cut piece member 1303 parallel to other cut piece members 1303 on a plane perpendicular to the direction of the axial center of the second mirror cylinder 1301, a projection 1304 projecting from an end of the cut piece member 1303 that is on the farther side to the axial center of the second mirror cylinder 1301 toward the fixed lens holding frame 119, and a leg 1305 supporting the other end of the cut piece member 1303 that is on the closer side to the axial center of the second mirror cylinder 1301. Each leg 1305 extends in parallel with the direction of the axial center of the second mirror cylinder 1301.

According to the zoom lens device of the second embodiment, when the adjusting screws 120 are screwed into the screw holes 121 to mount the fixed lens holding frame 119 on the second mirror cylinder 1301, the projections 1304 are brought in contact with the fixed lens holding frame 119. When the adjusting screws 120 are turned in the tightening direction from this point, the bent portions 1302 deform in such a way that the cut piece members 1303 are displaced to cause the projections 1304 to move toward the second mirror cylinder 1301. At this time, the legs 1305 may be curved to displace the cut piece members 1303, thus causes the projections 1304 to move toward the second mirror cylinder 1301.

According to the zoom lens device of the second embodiment, as described above, the unsteadiness of the fixed lens holding frame 119 against the second mirror cylinder 1301 can be suppressed only by mounting the fixed lens holding frame 119 on the second mirror cylinder 1301. This allows stable mounting of the l1 lens 105 and the L2 lens 104.

According to the zoom lens device of the second embodiment, the unsteadiness of the fixed lens holding frame 119 against the second mirror cylinder 1301 is suppressed while the fixed lens holding frame 119 is kept mounted on the second mirror cylinder 1301. The state of mounting of the l1 lens 105 and the L2 lens 104, therefore, can be adjusted easily as the fixed lens holding frame 119 is kept mounted on the second mirror cylinder 1301.

According to the zoom lens device of the second embodiment, the unsteadiness of the fixed lens holding frame 119 against the second mirror cylinder 1301 can be suppressed only by mounting the fixed lens holding frame 119 on the second mirror cylinder 1301 in a process of assembling the zoom lens device. This allows stable mounting of the l1 lens 105 and the L2 lens 104 by fewer assembling processes.

Since the zoom lens device of the second embodiment is provided with the bent portions 1302 formed integrally on the second mirror cylinder 1301, the unsteadiness of the fixed lens holding frame 119 against the second mirror cylinder 1301 can be suppressed only by mounting the fixed lens holding frame 119 on the second mirror cylinder 1301 without adding new components to the device or carrying out additional assembling work. This allows stable mounting of the l1 lens 105 and the L2 lens 104 with fewer components and by fewer assembling processes.

While the second embodiment relates to the zoom lens device having the bent portions 1302 formed on the second mirror cylinder 1301, the location of the bent portions 1302 is not limited to the case explained in the second embodiment. Though no illustration is given here, the bent portions 1302 may be formed on the fixed lens holding frame 119, or, for example, on both second mirror cylinder 1301 and fixed lens holding frame 119.

FIG. 14 is cross-section of a part of a zoom lens device according to a third embodiment of the present invention. In FIG. 14, the same components as in the first and second embodiments are denoted by the same reference characters given in the first and second embodiments, and are not described further.

As shown in FIG. 14, a zoom lens device 1400 of the third embodiment is further provided with a leaning gap adjusting plate 1401 placed between the mount 108 and the first mirror cylinder 109. The mount 108 and the first mirror cylinder 109 are connected by screwing flat-bar (FB) adjusting screws 1402 of pin-like members into screw holes that are formed on the first mirror cylinder 109.

Although not shown, the leaning gap adjusting plate 1401, in the same manner as the leaning gap adjusting plates 122, 1101, 1201 described in the first embodiment, has such bent portions that cause force to separate the mount 108 and the first mirror cylinder 109 away from each other, to act on the mount 108 and the first mirror cylinder 109 uniformly over the perimeter of the optical axis.

As described above, according to the zoom lens device 1400 of the third embodiment, placing the leaning gap adjusting plate 1401 between the mount 108 and the first mirror cylinder 109 allows stable mounting of the zoom lens device 1400 as a whole on the mount 108 and also allows adjustment of the state of mounting of the zoom lens device 1400 as a whole.

According to the zoom lens device 100 of the third embodiment, optical axis adjustment can be carried out between the second mirror cylinder 110 and the fixed lens holding frame 119, and also between the mount 108 and the first mirror cylinder 109. This leads to a further improvement in the precision of optical axis adjustment.

In another application, bent portions (no drawing is given) similar to the bent portions 1302 as described above may be formed on at least either the mount 108 or the first mirror cylinder 109, so that the first mirror cylinder 109 is mounted on the mount 108 without interposing the leaning gap adjusting plates 1401 between the mount 108 and the mirror cylinder 109.

According to the embodiments of the present invention, optical members can be mounted stably on an optical device, and the state of mounting of the optical members can be adjusted easily.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2006-152374 filed in Japan on May 31, 2006.

What is claimed is:

1. An optical member support mechanism comprising:
a holding member configured to hold an optical member among a plurality of optical members aligned along an optical axis;
a supporting member having a mounting surface facing the holding member in a direction of the optical axis;
a mounting unit configured to mount the holding member on the supporting member; and
a gap adjusting member arranged between the holding member and the supporting member, wherein
the gap adjusting member is configured to apply force acting on the holding member and the supporting member in such a direction that the holding member and supporting member are separated away from each other.

2. The optical member support mechanism of claim 1, wherein
the gap adjusting member includes bent portions that have elasticity and are formed by bending a part of the gap adjusting member toward at least one of the holding member and the mounting surface, and
the force is applied utilizing the elasticity.

3. The optical member support mechanism according to claim 1, wherein
the mounting unit includes a pin-formed member and a hole to which the pin-formed member is inserted, and
a distance between the holding member and the mounting surface in the direction of the optical axis is changeable by changing a position of the pin-formed member in the hole in the direction of the optical axis at a mounting position on the mounting surface.

4. The optical member support mechanism according to claim 3, wherein
the mounting position is arranged in plurality along a circle coaxial to the optical axis, and
each of the bent portions is arranged at a portion to be near each mounting position.

5. The optical member support mechanism according to claim 4, wherein number of the mounting positions is three.

6. The optical member support mechanism of claim 3, wherein
the mounting position is arranged in plurality along a circle coaxial to the optical axis, and
each of the bent portions is arranged at a portion corresponding to substantially middle between two mounting positions adjacent to each other.

7. The optical member support mechanism according to claim 6, wherein number of the mounting positions is three.

8. An optical member support mechanism comprising:
a holding member configured to hold an optical member among a plurality of optical members aligned along an optical axis;
a supporting member having a mounting surface facing the holding member in a direction of the optical axis; and
a mounting unit configured to mount the holding member on the supporting member, wherein
at least one of the holding member and the supporting member is configured to apply force acting on at least one of the holding member and the supporting member in such a direction that the holding member and supporting member are separated away from each other.

9. The optical member support mechanism of claim 8, wherein
at least one of the holding member and the supporting member includes bent portions that have elasticity and are formed by bending a part of at least one of the holding member and the supporting member toward any one of the supporting member or the mounting surface, and
the force is applied utilizing the elasticity.

10. The optical member support mechanism according to claim 9, wherein the bent portions are molded integrally with least one of the holding member and the supporting member.

11. An optical device including the optical members supported by the optical member support mechanism according to claim 1.

12. A gap adjusting member arranged between a holding member and a supporting member, the holding member configured to hold an optical member among a plurality of optical members aligned along an optical axis, the supporting member having a mounting surface facing the holding member in a direction of the optical axis, the gap adjusting member comprising bent portions that have elasticity and are formed by bending a part of the gap adjusting member toward at least one of the holding member and the mounting surface, wherein
the gap adjusting member is configured to apply force acting on the holding member and the supporting member in such a direction that the holding member and supporting member are separated away from each other.
